(19) United States
(12) Patent Application Publication
(10) Pub. No.: US 2026/0038894 A1
(43) Pub. Date: Feb. 5, 2026

(54) BATTERY CELL AND SYSTEM AND METHOD FOR ANALYSIS THEREOF

(71) Applicant: GM GLOBAL TECHNOLOGY OPERATIONS LLC, Detroit, MI (US)

(72) Inventors: Michelle H. Wiebenga, Farmington Hills, MI (US); Vamakshi Yadav, Sterling Heights, MI (US); Alexander Millerman, Bloomfield Township, MI (US); Jing Gao, Rochester, MI (US); Brian J. Koch, Berkley, MI (US)

(73) Assignee: GM GLOBAL TECHNOLOGY OPERATIONS LLC, Detroit, MI (US)

(21) Appl. No.: 18/794,240

(22) Filed: Aug. 5, 2024

(51) Int. Cl. H01M 10/48; H01M 4/485; H01M 4/58; H01M 4/66; H01M 50/342; H01M 50/569

(52) U.S. Cl. CPC H01M 10/48; H01M 4/485; H01M 4/5825; H01M 4/661; H01M 50/342; H01M 50/569; H01M 2220/20

(57) ABSTRACT

A battery cell includes a housing defining a battery cell space within the housing, a cathode disposed within the battery cell space, an anode disposed within the battery cell space, a reference electrode disposed within the battery cell space, and electrolyte disposed within the battery cell space and in contact with the cathode, the anode, and the reference electrode. The housing has a gas analysis port in fluid communication with the battery cell space and extending to an exterior of the housing.

### INTRODUCTION

This disclosure is in the field of battery cells and systems and methods for analyzing battery cells.

In a battery cell, testing for and identifying causes of cell degradation may help provide for improvement of battery cell design. Testing for cell degradation may also provide early indication of degradation of an in-service battery cell, which may provide the opportunity for proactive replacement of a vehicle battery.

### SUMMARY

A battery cell includes a housing defining a battery cell space within the housing, a cathode disposed within the battery cell space, an anode disposed within the battery cell space, a reference electrode disposed within the battery cell space, and electrolyte disposed within the battery cell space and in contact with the cathode, the anode, and the reference electrode. The housing has a gas analysis port in fluid communication with the battery cell space and extending to an exterior of the housing. The reference electrode may be disposed at an electrical potential between electrical potentials of the anode and the cathode. Further, the reference electrode may be physically disposed between the anode and the cathode as part of an electrode stack of the battery cell.

The housing may further include an electrically-conductive first housing portion in electrical contact with the cathode, an electrically-conductive second housing portion in electrical contact with the anode, and an electrically-conductive third housing portion is electrical contact with the reference electrode. The first housing portion, the second housing portion, and the third housing portion may be electrically insulated from one another. The battery cell may generate two half-cell voltages, with the reference electrode disposed to sense the half-cell voltages. The reference electrode may include an electrically-active portion that includes lithium fluorophosphate (“LFP”) or lithium titanate (“LTO”). Further, the reference electrode may include an electrically-active portion that includes thin-film LFP. Furthermore, the reference electrode may include a current collector that includes gold in electrical contact with the electrically-active portion.

A battery testing method includes providing a battery cell that includes a housing defining a battery cell space within the housing and having a gas port in fluid communication with the battery cell space. The method also includes providing within the battery cell space a cathode, an anode, and a reference electrode electrically between the cathode and the anode, and electrolyte in contact with the cathode, the anode, and the reference electrode. The method further includes analyzing gas emitted through the gas port.

In the battery testing method, the reference electrode may be disposed to sense a first half-cell voltage between the reference electrode and the cathode and to sense a second half-cell voltage between the reference electrode and the cathode. The method may further include measuring at least one of the first half-cell voltage and the second half-cell voltage.

The battery testing method may also include analyzing roles played by at least one of the anode and the cathode in generating gas generated in the battery cell. The method may also include heating the battery cell. The reference electrode may have an electrically-active portion including LFP or LTO. The electrically-active portion may include thin-film LFP. The reference electrode may include a current collector that includes gold in electrical contact with the electrically-active portion.

In the battery testing method, analyzing gas emitted through the gas port may include measuring a concentration of carbon dioxide emitted through the gas port. Analyzing gas emitted through the gas port may also or alternatively include measuring a concentration of hydrogen or other gases emitted through the gas port. The other gases may include ethylene, methane, ethane, and/or carbon monoxide.

A vehicle includes an electric propulsion system and a battery cell in electrical communication with the electrical propulsion system to provide, at least in part, electrical power for propulsion of the vehicle. The battery cell includes a housing defining a battery cell space within the housing and having a gas port in fluid communication with the battery cell space and an anode, a cathode, and a reference electrode disposed within the housing with the reference electrode electrically between the cathode and the anode, the reference electrode disposed to sense a first half-cell voltage between the reference electrode and the cathode and to sense a second half-cell voltage between the reference electrode and the cathode. The vehicle also includes one or more electronic controllers collectively programmed with instructions that when executed by the one or more electronic controllers cause the one or more electronic controllers to analyze gas generated in the battery cell and measure at least one of the first half-cell voltage and the second half-cell voltage. The instruction to analyze gas generated in the battery cell may include an instruction to analyze concentrations of one or more gases generated in the battery cell. The one or more electronic controllers may be further collectively programmed with instructions that when executed by the one or more electronic controllers cause the one or more electronic controllers to analyze roles played by at least one of the anode and the cathode in generating gas generated in the battery cell. The one or more gases may include hydrogen. The one or more gases may include carbon dioxide. The one or more other gases may also include ethylene, methane, ethane, and/or carbon monoxide.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 is a perspective view of a battery cell.

FIG. 2 is a cross-sectional view of the battery cell.

FIG. 3 is a magnified view of the cross section of FIG. 2.

FIG. 4 is a cross-sectional view of a reference electrode for the battery cell.

FIG. 5 is a cross-sectional view of an electrode stack for the battery cell.

FIG. 6 is a test setup for the battery cell.

FIG. 7 is a block diagram, in part, of an electrical propulsion system of a vehicle.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

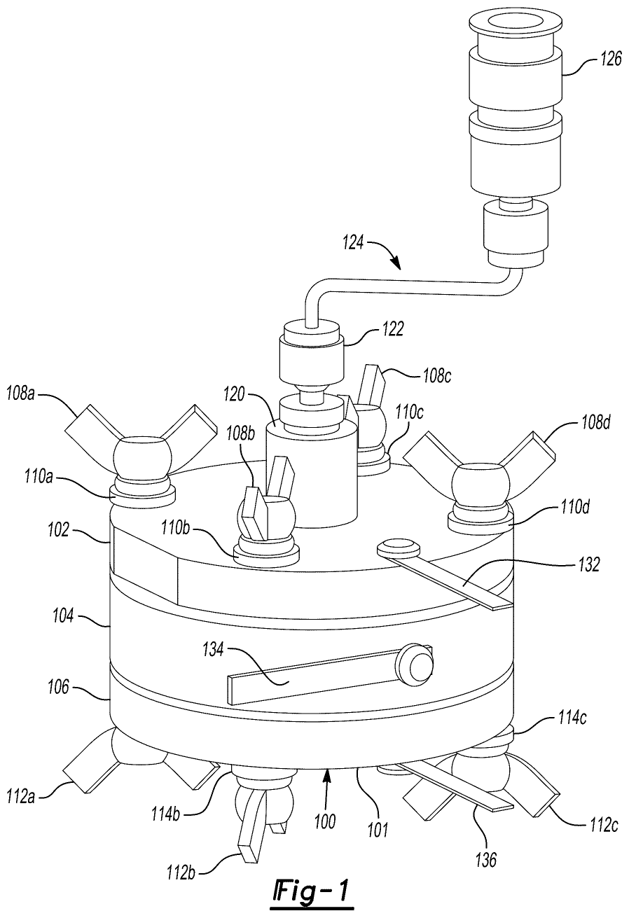

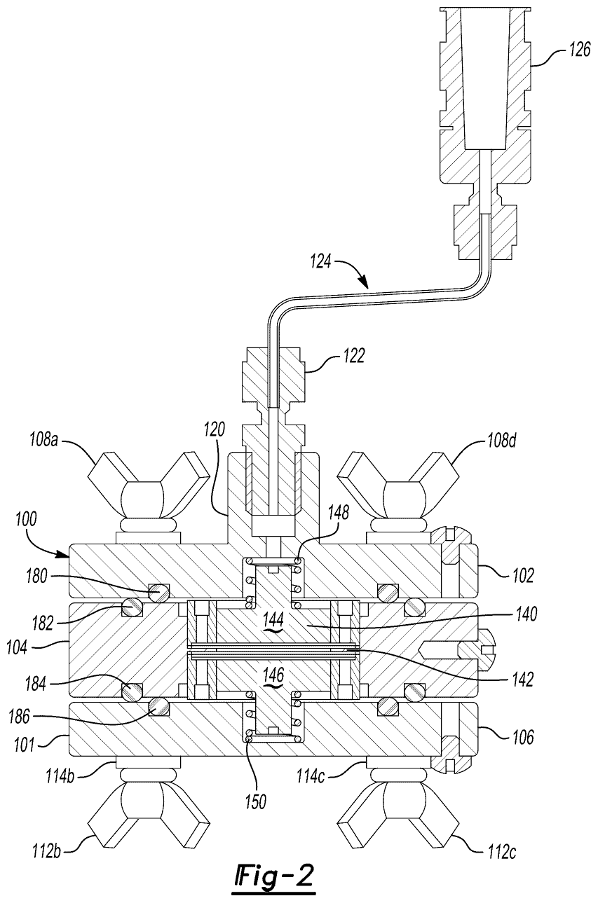

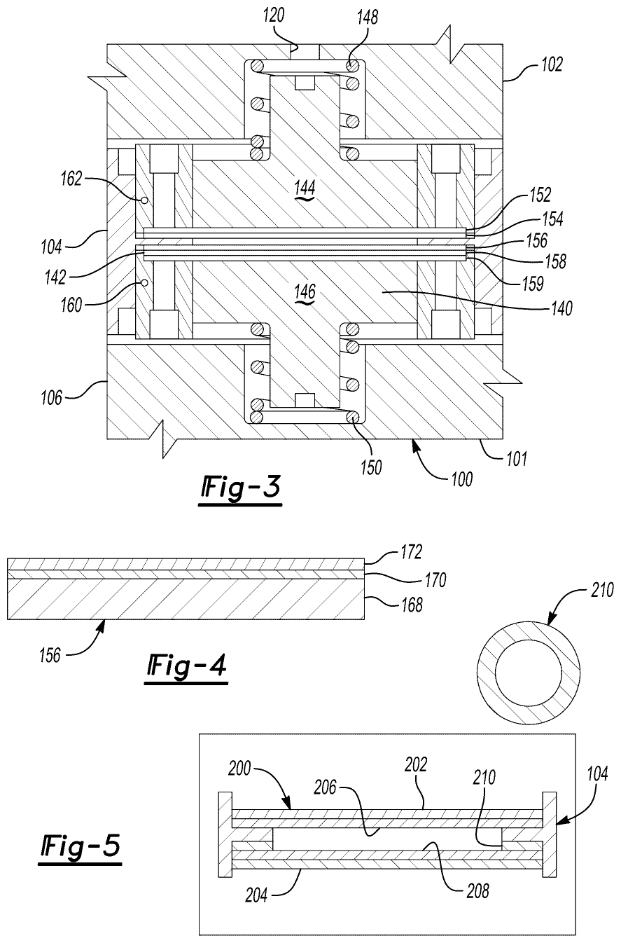

Refer first to FIG. 1, FIG. 2, and FIG. 3, which illustrate a battery cell 100. Battery cell 100 may be a lithium-ion battery cell, though other battery chemistries are contemplated by this disclosure as well. Battery cell 100 may include a housing 101 that itself includes a housing portion 102, a housing portion 104, and a housing portion 106. Housing portion 102, housing portion 104, and housing portion 106 may each be rigid and may be constructed of metal, such as stainless steel. Housing portion 104 may be coated with an electrically-insulating material which, depending upon the potential for battery cell 100 to be exposed to high temperatures, may be polytetrafluoroethylene (“PTFE”). Housing portion 102 may be affixed to housing portion 104 using one or more fasteners. The one or more fasteners may include four wing head bolts, wing head bolt 108a, wing head bolt 108b, wing head bolt 108c, and wing head bolt 108d. The wing head bolts may be screwed into corresponding threaded holes in housing portion 104. The wing head bolts may be electrically isolated from housing portion 102 and housing portion 104 by electrically insulating bushings. The electrically insulating bushings may include bushing 110a, bushing 110b, bushing 110c, and bushing 110d.

Housing portion 106 may be affixed to housing portion 104 in a similar manner, using fasteners such as wing bolts screwed into threads in housing portion 104. Four wing bolts may be provided for this purpose, three of which, wing bolt 112a, wing bolt 112b, and wing bolt 112c, are visible in FIG. 1. Corresponding electrically insulating bushings may also be provided to insulate the wing bolts from housing portion 106. Bushing 114b and bushing 114c are visible in FIG. 1.

A gas port 120 may be provided in housing portion 102. Gas port 120 may communicate with the interior of housing 101 of battery cell 100. A suitable fitting 122, tubing 124, and quick disconnect fitting 126 may be installed on gas port 120. Quick disconnect fitting 126 may provide for simple connection of tubing or piping to (and disconnection from) an analyzer or controller adapted to analyze gases generated within battery cell 100. Quick disconnect fitting 126 may be closed to gas flow therethrough until such tubing or piping to an analyzer is connected, allowing gases to accumulate within battery cell 100 for subsequent sampling and analysis. Quick disconnect fitting 126 may also have an electrically-controlled valve that may selectively be opened and closed by an analyzer to allow gases to accumulate in battery cell 100 (when the valve is closed) and passed to the analyzer (when the valve is opened) for sampling and analysis. A purpose of quick disconnect fitting 126 may be to allow multiple battery cells to be temporarily connected in turn to an analyzer for analysis of gases generated in such battery cells. Quick disconnect fitting 126 may be replaced by or supplemented with another type of valve for selectively sealing the cell space 140 of battery cell 100, such as a toggle valve, ball valve, check valve, or others. Gas port 120 may be distinguished from a vent, in that gas port 120 may be adapted for connection of a valve and tubing or piping for collecting and subsequently analyzing gas generated in battery cell 100.

Seals such as O-ring 180, O-ring 182, O-ring 184, and O-ring 186, may provide a seal for cell space 140. The seals or O-rings may be made of materials suitable for the temperatures to which battery cell 100 will be exposed when battery cell 100 is tested. The O-rings may, for instance, be silicone or PTFE.

Three electrical terminals may be provided on battery cell 100. Terminal 132 may be mechanically and electrically coupled to housing portion 102 by a fastener such as a screw or by other suitable fastening methods. Terminal 134 may be mechanically and electrically coupled to housing portion 104 by a fastener such as a screw or by other suitable fastening methods. Terminal 136 may be mechanically and electrically coupled to housing portion 106 by a fastener such as a screw or by other suitable fastening methods. Terminal 132, terminal 134, and terminal 136 provide the ability to externally connect to the electrodes of battery cell 100, as will be described in more detail hereinafter.

Housing 101 defines a sealed battery cell space 140 within housing 101. Included in battery cell space 140 is an electrode stack 142. Also included in battery cell space 140 are first spacer 144 and second spacer 146. First spacer 144 and second spacer 146 may be made of metal, such as stainless steel. First spacer 144 and second spacer 146 may be biased toward electrode stack 142 by first spring 148 and second spring 150.

Electrode stack 142 may include a first electrode 152. First electrode 152 may be a “working electrode” of battery cell 100 and as such, first electrode 152 may be an anode or a cathode of battery cell 100. If a cathode, first electrode 152 may be of nickel-cobalt-manganese-aluminum (“NCMA”) composition, though various other compositions may certainly be used for various chemistries of battery cell 100. Electrode stack 142 may also include a separator 154. Separator 154 may be electrically insulating and, as such, may be made of a plastic such as polypropylene. Separator 154 is constructed to be permeable to the electrolyte used in battery cell 100; as such, separator 154 may be annular or may be disc-shaped with openings therein.

Electrode stack 142 may also include a reference electrode 156, alternative constructions of which will be described hereinafter.

Electrode stack 142 may also include a separator 158. Separator 158 is constructed to be permeable to the electrolyte used in battery cell 100. Separator 158 may be electrically insulating and, as such, may be made of a plastic such as polypropylene. Electrode stack 142 may also include a second electrode 159, which may be a “working electrode,” that is, an anode or cathode, of battery cell 100. If an anode, second electrode 159 may be composed of or comprise graphite, though various compositions may certainly be used for various chemistries of battery cell 100. Separator 154 and separator 158 are designed to be stable when exposed to the temperatures to which battery cell 100 is expected to be exposed. As such, separator 154 and separator 158 may be made of polypropylene, PTFE, or other electrically-insulating construction appropriate for the temperatures to which battery cell 100 will be exposed.

An appropriate electrolyte for the battery chemistry of battery cell 100 is provided in cell space 140. The electrolyte may comprise lithium and may by way of example be lithium hexafluorophosphate. Spacer 160 and spacer 162 may be provided, within which spacer 144 and spacer 146 may be guided. Spacer 160 and spacer 162 may be constructed of polypropylene, PTFE, or other electrically-insulating construction, as appropriate for the conditions to which battery cell 100 will be exposed.

First electrode 152 may be in electrical contact with housing portion 102. As such, terminal 132 may be in electrical contact with first electrode 152, allowing for external connection with first electrode 152.

Second electrode 159 may be in electrical contact with housing portion 106. As such, terminal 136 may be in electrical contact with second electrode 159, allowing for external connection with second electrode 159.

Reference electrode 156 may be in electrical contact with housing portion 104. As such, terminal 134 may be in electrical contact with reference electrode 156, allowing for external connection with reference electrode 156.

Reference electrode 156 is disposed within battery cell space 140 such that it can sense the half-cell voltages of battery cell 100. Reference electrode 156 may be at an electrical potential that is between electrical potentials of first electrode 152 and second electrode 159. Reference electrode 156 may also be physically between first electrode 152 and second electrode 159.

Reference electrode 156 may be constructed as shown in FIG. 4. Reference electrode 156 may include separator 168. Reference electrode 156 may also include electrically-active material 170. Such electrically-active material may be or may include lithium ferrophosphate (“LFP”), which may be disposed by thin film deposition. Included in electrically-conductive relation with electrically-active material 170 may be a current collector 172, which may be in electrical contact with housing portion 104. Current collector 172 may be metallic. Current collector 172 may comprise gold. The gold may be applied by sputtering. The method of manufacturing reference electrode 156 may be or may include the method described in U.S. Pat. No. 11,374,268 B2 by Gao et al. and assigned to GM Global Technology Operations LLC, the entirety of which is incorporated by reference herein.

Battery cell 100 may be tested at various temperatures in order to understand the behavior of battery cell 100 at such temperatures, including gases that may be emitted in connection with degradation of first electrode 152 and second electrode 159. Such temperatures may, purely by way of nonlimiting example, be in the range of 25° C. to heating to 175° C. The use of reference electrode 156 using LFP active material and a gold current collector has been observed to emit very low levels of gases when battery cell 100 is in that temperature range of interest and, further, to at least 190° C. As such, reference electrode 156 using such materials has been observed to be advantageous in testing and analysis of battery cell 100, in that gases potentially emitted by reference electrode 156 will not skew the measurement and analysis of gases emitted from first electrode 152 and/or second electrode 159. Reference electrode 156 may also contain or include lithium titanate (LTO), which may be advantageous as being stable in the voltage and temperature conditions in which battery cell 100 may operate.

Refer now to FIG. 5. Lithium metal may also be used as the electrically-active material in the reference electrode 156 for battery cell 100. As such, an alternative electrode stack 200 for battery cell 100 may comprise a first electrode 202, which may be a cathode comprising or composed of NCMA. Electrode stack 200 may comprise a second electrode 204, which may be an anode comprising or composed of graphite. Further, electrode stack 200 may include first separator 206 and second separator 208, each of which may be electrically insulating and designed of a material that is suitable to the expected operational temperature range, such as polypropylene, PTFE, or other suitable electrically-insulating construction. Electrode stack 200 may also include a lithium metal ring 210 as the electrically-active material to form a reference electrode in electrode stack 200. Lithium metal ring 210 may be annular.

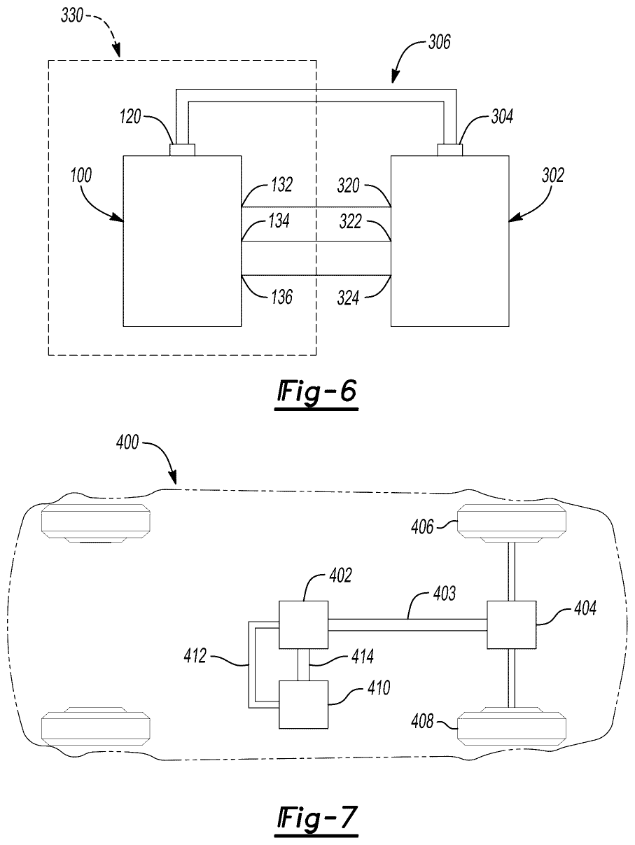

Refer now to FIG. 6. There, a test setup for testing battery cell 100 is illustrated. An analyzer 302 may be adapted for testing battery cell 100. Analyzer 302 may have a port 304 that is connected by suitable tubing or piping 306 to port 120 of battery cell 100. As so connected, analyzer 302 may analyze the gases generated within battery cell 100, such as by measuring the concentrations of one or more of the constituent gases generated within battery cell 100. Depending upon the battery chemistry involved, those gases may include hydrogen, carbon dioxide, ethylene, methane, ethane, and/or carbon monoxide, and/or others. Further, then, terminal 132, terminal 134, and terminal 136 of battery cell 100 may be electrically coupled to counterpart terminal 320, terminal 322, and terminal 324 of analyzer 302. In that way, analyzer 302 may measure the half-cell voltages of battery cell 100 via terminal 132, terminal 134, and terminal 136, including the half-cell voltage between terminal 132 and 134 and the half-cell voltage between terminal 134 and terminal 136. Those half-cell voltages, along with the concentrations of gases generated, may be used to analyze (e.g., deconvolute) the potential causes of decomposition of the working electrodes of battery cell 100. That is, by analyzing the gases, and concentrations thereof, emitted by battery cell 100 and measuring the respective half-cell voltages (where the gas generation and half-cell voltages may be correlated with one another and with decomposition of the working electrodes), the possible decomposition of the working electrodes (such as first electrode 152 and second electrode 159) may be predicted, quantified, and the mechanisms of decomposition understood. Gas-generating chemical reactions may be associated with voltage changes at either or both of the working electrodes, first electrode 152 and second electrode 159. Analyzer 302 may analyze roles played by at least one of the anode and the cathode in generating gas generated in battery cell 100.

Analysis of battery cell 100 may be by or may include the analysis method disclosed in copending and commonly-assigned U.S. patent application Ser. No. 18/535,583, filed Dec. 11, 2023, the contents of which are incorporated by reference herein.

Battery cell 100 may be disposed within a heater 330 such that the temperature of battery cell 100 may be raised in order to study decomposition of electrode 152 and/or electrode 159 at elevated temperatures.

Analyzer 302 may be a microprocessor based controller that should be understood to have suitable electronic resources (inputs, outputs, microcontroller, memory, software, peripherals, and the like) to perform the functions ascribed to analyzer 302 herein. Further, the functions of analyzer 302 may be distributed or shared among one or more additional controllers or instruments, with the additional controllers or instruments sharing data and computing responsibility. Analyzer 302 may include a potentiostat to manage testing of battery cell 100 and measure the half-cell voltages thereof.

Refer to FIG. 7. Illustrated there is a vehicle 400. Vehicle 400 may be an electric vehicle, namely, a vehicle that uses stored electrical energy for some or all of the propulsive energy for the vehicle. Vehicle 400 may be any type or style of vehicle and may be a car, truck, van, sport-utility vehicle, motorcycle, bicycle, boat, airplane, or other type or style of vehicle.

Vehicle 400 may contain a battery 402. Battery 402 may contain any number of battery cells that may be constructed consistently with battery cells disclosed in this disclosure. Battery 402 may be coupled via conductors 403 in an electrical power transferring relation with one or motors 404 that propel vehicle 400 using electrical energy stored in battery 402. Motors 404 may provide tractive power to drive wheel 406 and drive wheel 408. Vehicle 400 may also include an analyzer 410. Analyzer 410 may be constructed similarly to analyzer 302 in material respects. Analyzer 410 may also have additional responsibilities as a controller in vehicle 400. Analyzer 410 may be coupled to battery 402 via a tube or pipe 412, so that analyzer 410 can sample and analyze the gases emitted from battery 402. Circuitry 414 may connect analyzer 410 with battery 402 so that analyzer may make various electrical measurements of battery 402, including half-cell voltages of battery 402.

Again, analyzer 410 may analyze the gases that are generated in one or more of the battery cells that comprise battery 402. Such analysis may include measuring the concentrations of one or more gases that may be generated in the battery cells that comprise battery 402. Depending upon the battery chemistry involved, those gases may include hydrogen, carbon dioxide, ethylene, methane, ethane, and/or carbon monoxide. Analyzer 410 may also measure the half-cell voltages of one or more of the battery cells that comprise battery 402. By analyzing the gases emitted by the cells that comprise battery 402 and measuring the respective half-cell voltages, the possible decomposition of the working electrodes (such as first electrode 152 and second electrode 159) may be predicted and quantified. This may be used to identify degradation of battery 402 so that the owner of vehicle 400 may proactively have battery 402 replaced. It may also be used to collect data in order to understand the causes of degradation of the electrodes (including the relationship between half-cell voltages of battery 402 and the concentration of gases sampled by analyzer 410) and improve the design of battery 402 going forward.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims. Moreover, this disclosure expressly includes combinations and sub-combinations of the elements and features presented above and below.

What is claimed is:

1. A battery cell comprising:
a housing defining a battery cell space within the housing;
a cathode disposed within the battery cell space;
an anode disposed within the battery cell space;
a reference electrode disposed within the battery cell space;
electrolyte disposed within the battery cell space and in contact with the cathode, the anode, and the reference electrode; and
a gas port in the housing, the gas port in fluid communication with the battery cell space and extending to an exterior of the housing.

2. The battery cell of claim 1, wherein the housing further comprises:
an electrically-conductive first housing portion in electrical contact with the cathode;
an electrically-conductive second housing portion in electrical contact with the anode; and
an electrically-conductive third housing portion is electrical contact with the reference electrode;
wherein the first housing portion, the second housing portion, and the third housing portion are electrically insulated from one another.

3. The battery cell of claim 1, wherein the reference electrode is disposed at an electrical potential between electrical potentials of the anode and the cathode.

4. The battery cell of claim 2, wherein the reference electrode is physically disposed between the anode and the cathode as part of an electrode stack of the battery cell.

5. The battery cell of claim 1, wherein the battery cell generates two half-cell voltages, and the reference electrode is disposed to sense the half-cell voltages.

6. The battery cell of claim 2, wherein the reference electrode comprises an electrically-active portion comprising lithium fluorophosphate (“LFP”) or lithium titanate (“LTO”).

7. The battery cell of claim 6, wherein the reference electrode comprises an electrically-active portion comprising thin-film LFP.

8. The battery cell of claim 6, wherein the reference electrode includes a current collector comprising gold in electrical contact with the third housing portion.

9. A battery testing method comprising:
providing a battery cell including a housing defining a battery cell space within the housing and having a gas port in fluid communication with the battery cell space, a cathode within the battery cell space, an anode within the battery cell space, a reference electrode within the battery cell space, and electrolyte in contact with the cathode, the anode, and the reference electrode; and
analyzing gas emitted through the gas port.

10. The method of claim 9, wherein:
the reference electrode is disposed to sense a first half-cell voltage between the reference electrode and the cathode and to sense a second half-cell voltage between the reference electrode and the anode; and
the method further comprises measuring at least one of the first half-cell voltage and the second half-cell voltage.

11. The method of claim 10, further comprising analyzing roles played by at least one of the anode and the cathode in generating gas in the battery cell.

12. The method of claim 11, further comprising heating the battery cell.

13. The method of claim 9, wherein the reference electrode comprises an electrically-active portion comprising LFP or LTO.

14. The method of claim 13, wherein the reference electrode comprises an electrically-active portion comprising thin-film LFP.

15. The method of claim 14, wherein the reference electrode includes a current collector comprising gold in electrical contact with the electrically-active portion.

16. The method of claim 11, wherein analyzing gas emitted through the gas port includes measuring a concentration of carbon dioxide emitted through the gas port.

17. The method of claim 11, wherein analyzing gas emitted through the gas port includes measuring a concentration of hydrogen emitted through the gas port.

18. A vehicle comprising:
an electric propulsion system; and
a battery cell in electrical communication with the electrical propulsion system to provide, at least in part, electrical power for propulsion of the vehicle, the battery cell including:
a housing defining a battery cell space within the housing and having a gas port in fluid communication with the battery cell space; and
an anode, a cathode, and a reference electrode disposed within the battery cell space, the reference electrode disposed to sense a first half-cell voltage between the reference electrode and the cathode and to sense a second half-cell voltage between the reference electrode and the cathode; and
one or more electronic controllers collectively programmed with instructions that when executed by the one or more electronic controllers cause the one or more electronic controllers to:
analyze gas generated in the battery cell; and
measure at least one of the first half-cell voltage and the second half-cell voltage.

19. The vehicle of claim 18, wherein the instruction to analyze gas generated in the battery cell includes an instruction to analyze concentrations of one or more gases generated in the battery cell.

20. The vehicle of claim 19, wherein the one or more electronic controllers are further collectively programmed with instructions that when executed by the one or more electronic controllers cause the one or more electronic controllers to analyze roles played by at least one of the anode and the cathode in generating gas generated in the battery cell.
